(19) United States
(12) Patent Application Publication
(10) Pub. No.: US 2003/0204446 A1
(43) Pub. Date: Oct. 30, 2003

(54) One-beam, multi-person web interaction method

(76) Inventor: Richard D. Borovoy, Boston, MA (US)

Correspondence Address: FISH & RICHARDSON P.C., 3300 DAIN RAUSCHER PLAZA, 60 SOUTH SIXTH STREET, MINNEAPOLIS, MN, 55402, US

(21) Appl. No.: 10/136,806

(22) Filed: Apr. 30, 2002

(51) Int. Cl. G06F 17/60

(52) U.S. Cl. 705/26

(57) ABSTRACT

This invention improves face-to-face communication between two PDA users. Data contained in a first of the two user's PDA is required to perform an interaction by the second PDA with the World Wide Web (the “web”). For example, the first PDA can contain a description of a product or service, and can beam that description to another PDA. The recipient PDA then has everything it needs to interact with the web. PDAs typically contain the facility to send an infrared beam containing data to another compatible PDA. The data in the first PDA can be maintained as a beamable object, and beamed multiple times to different PDAs.

### TECHNICAL FIELD

This invention relates to a quick, improved, automatic method of exchanging data between two people in reasonably close proximity using their Personal Digital Assistants (“PDAs”), for the purpose of web interaction where data from both PDAs is required.

### BACKGROUND

In the past, web vendors, such as Amazon.com (hereinafter “Amazon”), have made great strides to minimize the amount of effort it takes to order a product on the web. Indeed, Amazon received U.S. Pat. No. 5,960,411 for its now famous “one-click” ordering method. That method allows a customer, using his or her web browser, to find an item on Amazon's web site, and then to click only one time on an “order” button associated with that product, and the order is automatically placed and a notice of the receipt of the order posted on the customer's browser. This is accomplished by the Amazon customer providing in advance shipping and billing information (such as a credit card). That data is stored either by Amazon or as part of a “cookie” on the customer's PC (or some combination of the two). Using the prior art, if a friend wants to provide an Amazon customer in a face-to-face setting with a description of a product sold by Amazon, of interest to that customer, he or she usually does it verbally. Sometimes the friend will write a note. Then the customer goes to Amazon's site and searches for the desired product. Upon finding it, he or she can order it in the usual manner, for example using “one click.” If the friend happened to have a description of that product on his or her PDA (such as a title of a book), she could beam that information to the Amazon customer's PDA. But then the Amazon customer must still sit before his PC, read the product data from his PDA, find the product on Amazon's site and then place the order. Even with wireless access to the web from his PDA, the customer who received the data would have to retype it into an Amazon order format. The receipt of the data by beam or written note would only make certain that the customer did not remember the data incorrectly, as she might if it were told to her verbally.

Alternatively, the friend can beam a URL of a particular item to the Amazon customer. This does not offer an easy or complete solution, however, because more clicks are required. The recipient must click to open the URL and then click again to execute the transaction, since most web servers (including Amazon's) are not set up to execute a transaction based solely upon connection to their URL.

Furthermore, for many web services, a single URL is insufficient for specifying the transaction. A static URL does not encode information, for example, about who had sent the URL to the recipient (if it did, the URL would not remain accurate if it was subsequently passed around in a chain-like fashion). Therefore any follow-on transactions that required the identification of the sender of the URL could not be completed. For example, a reward by Amazon to the sender who recommended the purchase of an Amazon product would not be possible by the mere beaming of URLs. Furthermore, raw URLs would be hard for a recipient to interpret. One URL looks very much like another.

Another prior art technique for communicating face-to-face is email. Assuming two people have “live” net connections, one person could email a URL to another person standing in front of him. As mentioned above, URL passing is not usually suitable for directly initiating a transaction. Furthermore, email exchange, which is not consensual, is not an appropriate medium for automatic ordering. You would not want to automatically place an order for an X-rated movie upon receipt of an email solicitation.

Another prior art beaming technique is called BeamCash. This allows one person to beam another person some money. The transaction is completed by a recipient when he synchs his PDA with his PC. BeamCash also requires that the sender enter an amount to be paid for every transaction. It is not possible for a sender to enter the transaction parameters once, and then specify the entire transaction by picking it from a list of objects thereafter. Therefore, in order for a person to execute the same transaction with several different people over time, he would have to enter the transaction data each time. For this reason, this method does not facilitate the same transaction propagating in a chain-like fashion from person to person. And BeamCash is limited to sending of cash.

Yet another prior art technique is called a “Zaplet.” Zaplets are unique because they facilitate web interaction for people via email. However, they are not designed to work for face-to-face communication.

### DESCRIPTION OF DRAWINGS

FIG. 1 is a web page showing a beamable object of the invention.

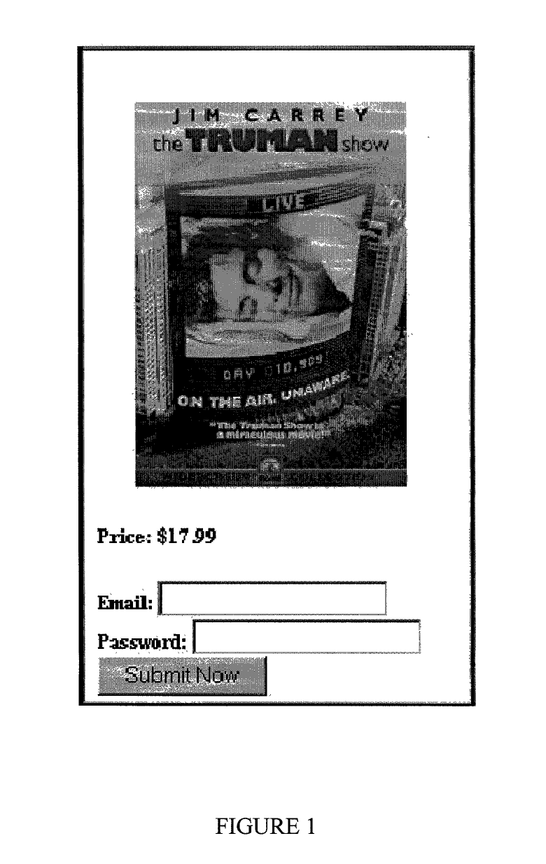

### SUMMARY

This invention improves face-to-face communication between two PDA users. Data contained in a first of the two user's PDA is required to perform an interaction by the second PDA with the World Wide Web (the “web”). For example, the first PDA can contain a description of a product or service, and can beam that description to another PDA. PDAs typically contain the facility to send an infrared beam containing data to another compatible PDA.

The second PDA can be used to place an order for that product or service on the web automatically the next time it connects to the web. This two person web interaction method of this invention makes possible the automatic ordering of a product or service from the web with just one beam from one PDA to another. As soon as the recipient PDA is or becomes logged on to the web, the transaction takes place. If the recipient is logged on all the time, the interaction occurs immediately upon receipt of the information from the first PDA. The first PDA provides the needed data to the second that the second does not already have, and that data combined with software on the second PDA is sufficient to complete the web transaction. This invention also makes it possible for the same “beamable transaction” to be passed around to multiple recipients in a chain-like fashion.

This invention requires a PDA user to have the necessary software to practice the invention. A web vendor, such as Amazon or Yahoo, may provide such software for a PDA. Ultimately a standard system may be agreed upon that supports multiple web vendors in the same manner as Adobe Acrobat supports many document publishers. For example, a web site provider such as Yahoo may provide some custom elements that will make the platform work with their servers. This software makes it possible for one person to enter product or service description data into her PDA in a form adapted to be sufficiently recognized by Yahoo's or another web vendor's web site to uniquely identify the desired product or service. On the complementary side, of course, Amazon's or Yahoo's web site must have the capability to recognize the product or service data in the form or format provided by the PDA.

Briefly, the method of the invention conducts a transaction with a web site using a second PDA that contains software that allows the completion of the transaction with the web site only after it receives certain other information necessary for the transaction from a first PDA. The first PDA provides the second PDA information via a link between them set up with the consent of the users of both PDAs. In most cases, the PDA users are in close proximity (beaming distance). If the second PDA does not have the required software, the first PDA may also beam that software. The second PDA uses this data or software, in addition to information already contained on the second PDA, to complete the transaction. In a preferred embodiment, more than two PDAs are used in a chain-like fashion.

The invention is not limited to ordering products or services. The essence of the invention is passing data from one PDA to another or to others in a form that can be used by the other PDAs to engage in an interaction with the web. The information provided by the first PDA cannot already be stored in the required form on the other PDAs, or the beamed information would be redundant. One of the recipient PDAs then connects to the web and executes the transaction. A big advantage of the invention is that the necessary data (and/or software) can be stored as a beamable object on a PDA, and can be sent to many other PDAs in separate transactions without changing the data. Therefore, if a PDA user wants to provide the title and other information of a book to several people so they can order it, the PDA user only needs to set up that beamable object one time. Thereafter, it is ready to be beamed to whoever wants it.

The details of one or more embodiments of the invention are set forth in the accompanying drawings and the description below. Other features, objects, and advantages of the invention will be apparent from the description and drawings, and from the claims.

### DETAILED DESCRIPTION

In a preferred embodiment of the method of this invention, Amazon, Yahoo or another web product or service vendor may provide software for a PDA that includes a dialog box wherein a customer can enter enough data to uniquely identify a product or service to be purchased or otherwise obtained on the web. Then, when that customer or potential customer of Amazon or Yahoo wants to provide that information to another customer who has the necessary software on his PDA, she could beam it from her PDA to the other customer's PDA. If desired, where the second customer not only lacks the product data, but also lacks the ordering software, provided the first customer has that ordering software on her PDA, the entire package can be passed from the first customer's PDA to the second via beaming.

Provided the second customer has his Amazon account information stored on his PDA (preferably within the One-beam software framework), and that second PDA is logged onto the web, the order will be placed automatically. If the recipient's PDA is not logged on, then all he needs to do is to log on and the software of this invention, to be provided on the second PDA, will automatically order the product, the identification of which was beamed to him by the first PDA. If the second customer did not have an Amazon account, the software on his PDA would ask him for the necessary information (such as “ship to” address and credit card data), and then the order would be placed automatically.

If the second customer had previously established herself as a customer of the web provider (and thus already had the requisite ordering information stored on his PDA, or the requisite data was otherwise in Amazon's possession), then the software on her PDA will automatically place the order for the product or service whenever her PDA is linked to a net connection with no additional input required.

The ordering software may be provided directly to all PDAs using this invention. This allows a PDA to enter the account information quickly and easily. If that software already resides on the second customer's PDA, for example, after receiving the beamed product or service information from a friend, the PDA can ask for entry of the shipping address information from the address book on the PDA. If the second PDA lacks the software, the first PDA can pass it along during the data exchange process. That would only have to be done once, and thereafter the second PDA can accept product or service data from another PDA and automatically complete the ordering process the next time he logged onto the web. If his PDA was continuously logged on, the order can be placed immediately after receipt of the beamed product identification.

Some of the user's account information could be stored in the software itself. However, often PDA users keep “business cards” or “address information” on their PDAs. The software for carrying out this invention can easily link to that stored data, combine it with credit card data (that also may be carried in the PDA's memory) and thus fully prepare the second PDA to send orders to the web upon receipt of a description of the product or service desired from another PDA.

For example, Microsoft provides a service called “Passport” which contains all the information required for a customer to make a purchase, including shipping addresses and credit card data. If contained in the second customer's PDA, that Passport data could be linked with the product or service data received from the first PDA by software contained in the second, recipient PDA. The combination of the Passport data from the second PDA and the product or service data received from the first PDA is sent by the second PDA to the web site when the second PDA logs on, or immediately if the second PDA is continuously logged on. The order is then placed automatically by the second PDA.

One advantage of the invention is that the data about the owner of the first PDA may be included in the information passed to the second PDA, and thus passed by the second PDA to the web site. In that way, if the web site were Amazon, for example, Amazon would know the identity of the person who recommended the book to the owner of the second PDA. Then Amazon could, for example, assign points for such recommendations, and when a certain amount of goods were purchased on the recommendation of a particular person, that person can receive a merchandise credit, for example, from Amazon. If the owner of the second PDA were to pass the same data on to a third PDA owner, the data that went to Amazon would get updated, and credits can be assigned to either the second PDA owner, or perhaps both the second and the first.

In another embodiment of the invention, a PC may be used together with the second PDA. When the second PDA “synchs” with the PC, the order may be automatically placed using a command in the second PC to connect to the appropriate web site and, upon connection, place the order. Of course, if the PDA itself can connect directly to the web, either wirelessly, through a phone link or through another low speed or broadband accessing method, it is not necessary to use the synching process at all. One customer's PDA can beam the product or service data to another's PDA. When the recipient PDA next connects to the web, the product or service will automatically be ordered. In the future, PDAs will be continuously logged on to the web. In that case, the order will be placed upon receipt of the beamed product or service identification. The second customer's PDA, of course, must contain the “Passport” or other form of necessary shipping and credit card information, and provide it to the web site. In this embodiment, all necessary software for placing the order resides in the second PDA.

It is important that orders do not get placed unintentionally. In this invention, the two parties are within line of sight of each other and normally communicating face-to-face. Therefore unintentional ordering can easily be avoided. One method of passing data from one PDA to another is by a connecting cable. It is not possible to connect to PDAs with a cable inadvertently. Both PDA users must do it deliberately. The more common method of sending information from one PDA to another is by “Beaming.” Beaming is essentially a consensual act. One PDA cannot beam another unless the recipient PDA is set up to receive the beam. The two PDA users are quite near each other and usually in verbal contact. The act of setting up a PDA to receive a message from another PDA implies consent to receive the message in the same way as using the connection of a cable. Beaming typically takes place within a room, and requires a “line-of-sight” infrared connection between the two PDAs.

This method is very different from PDAs or portable PCs connecting to the web through wireless access points that will, unless coded, receive beams from any PC within range without consent. It is also different from email, which is non-consensual, as discussed in the prior art section. Otherwise, there would be no junk emails.

For even more protection against inadvertent ordering, the ordering software on the PDA may require at least one click from the recipient PDA before the order is placed. This feature would give the recipient a chance to change his or her mind. That feature is not necessary, however. There can be a setting selection whereby the recipient, having received the beamed product or service information, can avoid this click if he or she is willing to place the order automatically when he or she logs on without further intervention. If so, the order will be placed automatically either immediately upon receipt of the beam, if the PDA is already connected to the web, or upon connecting the PDA with the web, or automatically upon synching the PDA to a PC.

Another use of the method of the invention is to provide a group of people with the capability to establish themselves as a group on the web, for example to use email software from Yahoo called “Yahoo Groups.” In this embodiment, the first PDA can beam sufficient information to interact with the web software, such as the Yahoo Group software, to form a group. The first PDA would contain its owner's individual data, as required to become a part of the group (for example, in the case of Yahoo Groups, that data might include her email address). When the second PDA receives the information from the first, it uses its own software provided in accordance with this invention to incorporate its owner's id (such as his business card, email address or ordering passwords, all of which, to take advantage of this invention, should be stored on his PDA). That data is then passed to the web application immediately if the second PDA is logged on, or automatically the next time it becomes logged on.

Of course, groups of many could use the same beaming technique. When anyone of the group logs on, not only her data, but also the data of any other PDA owner who previously had beamed his data to her PDA, indicating a desire to join the group, is provided to the web application. In this way, data about members of the group is chained, and the first PDA user in the chain to log onto the web not only provides her own data, but also that of everyone else in the chain who, prior to that log on, has passed his or her data to the PDA that logged on. If some potential members of the group are out of this chain, representing branches of a tree, their data will be passed to the web as soon as they, or someone ahead of them in their own chain, logs onto the web. The web application, of course, will recognize and ignore duplicate data.

This invention is useful for jointly ordering services as well. For example, if several people want to go rafting, their names may be accumulated in the manner described above. The collective information, including the application and payment information for each member of the group in a chain, will be sent to the web site of the rafting company as soon as one member of the group logs on. This allows, for example, a group who are together at the movies to quickly plan a future event that includes all of them by each beaming their id and other necessary data to one of them. If that person is logged on at the time, the event is automatically requested. If not, it will be requested when she logs on. In doing so, the entire group is automatically signed up. Using the Yahoo Group system, for example, as presently used, each member of the group must individually log on and enter his or her individual data. This invention enables only one member of the group to easily enter everyone's data into the system, as that data can be beamed to her by the others.

Description of Software Used to Implement a Preferred Embodiment

Program 1, below, is a web page that represents a beamable object in which the parameters of a transaction are encoded. This particular beamable object encodes the information necessary for the owner of the recipient PDA to purchase the “Truman Show” DVD from Amazon. When a PDA user is beamed this object and opens it in his AvantGo web browser, he can then order the DVD with a single confirming click. The DVD will be ordered immediately if the recipient's PDA has a live net connection, or otherwise when the recipient docks his PDA to a computer with a net connection. This embodiment of the invention requires no additional software on either the sender's or recipient's PDA. Additional custom software on the PDA can execute the order for the “Truman Show” DVD automatically after receiving the beam from another PDA. This embodiment requires that the recipient enter his Amazon account name and password. Additional custom software, however, as may readily be written by one of ordinary skill in the art, can automatically retrieve this information from the recipient's PDA memory.

When the form in Program 1 gets submitted (either immediately after the recipient confirms the transaction, or when he docks), it executes Program 2 (“Doit”), a Unix shell script which contacts the Amazon Web Server, and executes the transaction. Program 2 basically simulates the actions that the recipient would go through if he wanted to order the “Truman Show” DVD for himself on the Amazon web site. This is made somewhat complicated by Amazon's extensive use of cookies and unique session ids. Program 2 first initiates a web session with the Amazon server by calling shell script Program 3 (“Start”). Program 3 makes an http call to amazon.com, and stores the headers that are returned in a file. Program 4 (“InsertStrings”), another shell script, extracts the Amazon session id from this header file by calling Program 5 (“ExtractSID”), written in Perl. It then inserts the session id, as well as the user's account name, password and the product id into a copy of Program 6 (“Buy”), a web form template wrapped in a shell script that will be used to submit the order. Program 4 renames this custom copy of Program 6 “BuyPrime”, listed below as Program 7. Finally, Program 2 executes “BuyPrime”, which submits a web form to Amazon, and the order is placed.

```
Program 1: −Truman Show= Beamable Object
<HTML>
<HEAD>
<TITLE>The Truman Show ThingE</TITLE>
</HEAD>
<BODY>
<B>
<H3>The Truman Show ThingE</H3>
<img src=“http://www.sweetspotdesign.com/trumanshow.jpg” valign=left alt=“DVD Image”>
<BR>Price: $17.99
<BR>
<?PHP
  empty($FirstPass) ? # First pass if empty
  ShowForm():  # Display the form
  ShowResults($Email,$Password,$Item);
  exit;
?>
<?PHP
function ShowResults ($Email, $Password, $Item) {
  global $HTTP_USER_AGENT;
  system(“/home/borovoy/doit “.escapeshellarg($Email).” “.escapeshellarg($Password).”
  ”.escapeshellarg($Item));
  echo “Thanks $Email $Password $Item
  <BR>
  <H2>Dump of GLOBALS Array</H2>
  <UL>\n”;
  foreach ($GLOBALS as $Key=>$Value){
  echo “<LI>\$GLOBALS[\“$Key\”]=$Value\n”;
  } # End of foreach ($GLOBALS as $Key=>$Value)
  echo “</UL>\n”;
} # End of function ShowResults
function ShowForm() {
  global $PHP_SELF; # The path and name of this file
$HTML=<<<HTML
<FORM ACTION=“$PHP_SELF”>
  <INPUT TYPE=“HIDDEN” NAME=“FirstPass” VALLTE=“No”>
  Email: <INPUT TYPE=“Text” NAME=“Emai1”>
  <BR>Password: <INPUT TYPE=“Text” NAME=“Password”>
  <INPUT TYPE=“HIDDEN” NAME=“Item” VALUE=6305252521>
<BR><INPUT TYPE=“Submit” VALUE=“Submit Now”>
</FORM>
</B>
</BODY>
</HTML>
HTML;
echo $HTML;
} # End of function ShowForm
?>
Program 2: Doit
#args: email pwd bid
echo running doit
/home/borovoy/start #produces header file with session id
/home/borovoy/insertstrings $1 $2 $3 #gets session id out of header, makes buyprime
/home/borovoy/buyprime #orders books
Program 3: Start
/usr/local/bin/curl -L -b empty www.amazon.com/pocketpc -D headers
Program 4: InsertStrings
#args: email pwd bid
sid=‘/home/borovoy/extractsid.pl’
sed “s/˜˜˜EMAIL˜˜˜/$1/g;s/˜˜˜PWD˜˜˜/$2/g;s/˜˜˜SID˜˜˜/$sid/g;s/˜˜˜BID˜˜˜/$3/g”
/home/borovoy/buy >/home/borovoy/buyprime
Program 5: ExtractSid.pl
#!/usr/bin/perl
undef $1;
open(HEADER,“headers”);
$_=<READER>;
if (/session-id=(.*); path/m) {print $1};
$/ = “\n”;
Program 6: Buy
/usr/local/bin/curl -L -d “asin.˜˜˜BID˜˜˜=1&dropdown-selection=default-address&gift-
certificate-code=&maw=1&method=post&opt=af&page=templates%2Faa%2Fupda%2Fsign-
in.html&response=dt%2Fupda-1.0-pocketpc%2Fhandle-buy-box%3D˜˜˜BID˜˜˜%2Faa
%2Fupda%2Fone-click-thanks&submit.one-click-dropdown-purchase=Buy+Now+with+1-
Click&suggested.=&tag_value=pocketpc&template-name=aa%2Fupda%2Fitem&use-acct-
bal=true&email=˜˜˜EMAIL˜˜˜&action=sign-in&next-
page=aa%2Fupda%2Fsetup.html&password=˜˜˜PWD˜˜˜”-b headers
https://www.amazon.com/o/dt/upda-1.0-pocketpc/flex-sign-in-done/˜˜˜SID˜˜˜
Program 7: BuyPrime
/usr/local/bin/curl -L -d “asin.6305252521=1&dropdown-selection=default-address&gift-
certificate-code=&maw=1&method=post&opt=af&page=templates%2Faa%2Fupda%2Fsign-
in.html&response=dt%2Fupda-1.0-pocketpc%2Fhandle-buy-box%3D6305252521%2Faa
%2Fupda%2Foue-click-thanks&submit.one-click-dropdown-purchase=Buy+Now+with+1-
Click&suggested.=&tag_value=pocketpc&template-name=aa%2Fupda%2Fitem&use-acct-
bal=true&email=george@eberstadt.com&action=sign-in&next-
page=aa%2Fupda%2Fsetup.html&password=curious”-b headers
https://www.amazon.com/o/dt/upda-1.0-pocketpc/flex-sign-in-done/
```

This invention is not limited to the above examples but can find a wide variety of other applications whereby a beam from one PDA to another provides an essential element to a web interaction that is implemented when the recipient logs on. Therefore the spirit and scope of the invention should be limited only by the scope of the claims which follow.

What is claimed is:

1. A method for ordering a product or service using two PDAs, a second of which has the capability when connected to the web for interacting with a web site, and the first of which has the capability of passing data to the second, comprising:
storing a description of a product or service in a first PDA's memory;
passing the description from the first PDA to the second PDA, the second PDA having the capability to capture the description received from the first PDA;
whereby, when the second PDA is connected to the web, the order for the product or service is automatically placed using both the description received from the first PDA and the capability on the second PDA for interacting with a web site.

2. The method of claim 1 wherein the data is passed from the first PDA to the second PDA using an infrared beam from the first PDA directed to an infrared receiver on the second PDA.

3. A method for ordering a product or service using two PDAs, a second of which has the capability when connected to the web for interacting with a web site, and the first of which has the capability of passing data to the second, comprising:
passing data describing the product or service from a first PDA to a second PDA with consent of a user of the second PDA;
whereby the product or service is automatically ordered for an account contained in the second PDA whenever the second PDA is or becomes connected to the web, using the data describing the product or service received from the first PDA, and software which resides in the second PDA at the time a connection to the web takes place.

4. The method of claim 3 wherein the data is passed from the second PDA to the first PDA using an infrared beam from the second PDA directed to a receiver on the first PDA.

5. A method for ordering a product or service using two PDAs, comprising:
providing software to a second PDA that allows purchase of products or services from a vendor;
providing software for a first PDA that allows the PDA to pass information to the second PDA in a predetermined format describing the product or service, such information being required by a vendor of the product or service in order to purchase the product or service on the web;
whereby, when the second PDA is or becomes connected to the web, it can automatically place the order with the vendor using both the information provided by the first PDA and the software allowing purchase of products or services contained in the second PDA.

6. The method of claim 5 wherein the data is passed from the first PDA to the second PDA using an infrared beam from the first PDA directed to a receiver on the second PDA.

7. The method of claim 5 wherein the provided software allows one-click ordering and the order is placed by the second PDA using only one click.

8. A method for conducting a transaction with a web site using two PDAs, a second of which contains software that allows the completion of the transaction with a web site after it receives certain other information necessary for the transaction from a first PDA, comprising:
providing the other information from a first PDA to the second PDA via a link between them set up with the consent of the users of both PDAs, the other information not already being present on the second PDA and being required by the web site, in addition to information already contained on the second PDA, to complete the transaction;
placing the order with the web site when the second PDA is or becomes connected to the web.

9. The method of claim 8 wherein the data is passed from the first PDA to the second PDA using an infrared beam from the first PDA directed to a receiver on the second PDA.

10. The method of claim 8 wherein the software allows one-click ordering and the order is placed by the second PDA using only one click

11. The method of claim 8 wherein the second PDA must confirm the transaction in order for the transaction to take place.

12. The method of claim 11 wherein the confirmation takes place after logging onto the web.

13. The method of claim 8 wherein not only the data is passed from the first PDA, but also web-interaction software is passed by the first PDA to the second PDA.

14. The method of claim 9 wherein the range of the beam is within a normal room and within line-of-sight.

15. A method for conducting a transaction with a web site using a plurality of PDAs, at least two of which contain software that allows the completion of the transaction with a web site after they receive certain other information necessary for the transaction from a third PDA, comprising:
providing the other information from the third PDA to each of the two PDAs via a link between them set up with the consent of the users of all three PDAs, the other information not already being present on either of the two PDAs and being required by the web site, in addition to information already contained on each of the two PDAs, to complete the transaction.

16. The method of claim 15 wherein the data is passed from the third PDA to the other PDAs using an infrared beam from the first PDA directed to a receiver on the other PDAs.

17. The method of claim 15 wherein the not only the data is passed by the third PDA, but also required web-interaction software is passed by the third PDA.

18. The method of claim 15 wherein the two PDAs must confirm the transaction before the transaction can take place.

19. The method of claim 16 wherein the range of the beam is within a normal room and within line-of-sight.

20. The method of claim 15 wherein both PDAs receiving information from the third PDA individually place the order when they are or become connected to the web.

21. A method for conducting a transaction with a web site using a plurality of PDAs, at least a first and second of which contain software that allows the completion of the transaction with a web site after they receive certain other information necessary for the transaction from a third PDA, comprising:
providing the other information from the third PDA to a second PDA via a link between them set up with the consent of the users of both PDAs, the other information not already being present on the second PDA and being required by the web site, in addition to information already contained on the second PDA, to complete the transaction;
providing the other information from the second PDA to a first PDA via a link between them set up with the consent of the users of both PDAs, the other information not already being present on the first PDA and being required by the web site, in addition to information already contained on the first PDA, to complete the transaction; and
the first and second PDAs separately completing the transaction when they are or become connected to the web.

22. The method of claim 21 wherein the data is passed from the third PDA to the second PDA, and from the second PDA to the first PDA using an infrared beam.
